(19) United States
(12) Patent Application Publication
(10) Pub. No.: US 2016/0011929 A1
(43) Pub. Date: Jan. 14, 2016

(54) METHODS FOR FACILITATING HIGH AVAILABILITY STORAGE SERVICES IN VIRTUALIZED CLOUD ENVIRONMENTS AND DEVICES THEREOF

(71) Applicant: NetApp, Inc., Sunnyvale, CA (US)

(72) Inventors: Joseph Caradonna, Ashland, MA (US); Rajesh Rajaraman, Acton, MA (US); Jason Goldschmidt, Newton, MA (US)

(21) Appl. No.: 14/325,897

(22) Filed: Jul. 8, 2014

(51) Int. Cl. G06F 11/07; G06F 3/06

(52) U.S. Cl. CPC G06F 11/0793; G06F 11/0727; G06F 3/0619; G06F 3/0635; G06F 3/067

(57) ABSTRACT

A method, non-transitory computer readable medium and host device that monitors an active virtual storage controller. A determination of when a failure of the active virtual storage controller has occurred is made based on the monitoring. When the failure of the active virtual storage controller is determined to have occurred, one or more storage devices previously assigned to the active virtual storage controller are remapped to a passive virtual storage controller and one or more transactions in a transaction log are replayed.

### FIELD

This technology relates to failover in data storage networks, and more particularly to methods and devices for providing high availability storage services on virtual or cloud data storage platforms.

### BACKGROUND

A storage fabric may include multiple storage controllers, including physical and/or virtual storage controllers, which store and manage data on behalf of clients. Applications utilizing such storage systems rely on continuous data availability. Accordingly, with respect to physical storage controllers, one common technique to provide high availability is to cross wire storage drives or fabric between two physical storage controllers to provide a seamless transfer if one of the physical storage controllers fails.

While both physical storage controllers can operate simultaneously, neither physical storage controller should operate at greater than half capacity since each of the physical storage controller may need to service the traffic previously serviced by a failed one of the physical storage controllers. Accordingly, providing high availability in the context of physical storage controllers requires maintaining significantly underutilized storage controllers with excess headroom, which is undesirable particularly considering the relatively high cost of the hardware required to implement the physical storage controllers.

While virtual storage controllers generally require relatively lower cost to implement than physical storage controllers, and therefore underutilization is not a significant concern, platforms on which virtual storage controllers are implemented may not allow sharing of the same storage drives or fabric between virtual storage controllers or, more specifically, the virtual machines on which the virtual storage controllers are executed. Accordingly, cloud platforms do not necessarily offer virtual controllers a shared storage fabric.

Instead, high availability for cloud platforms is often implemented using mirroring of the stored data which requires replication and associated storage costs, which can be significant. Another technique is simply to reboot a failed virtual storage controller, which generally takes on the order of several minutes. However, applications relying on the services provided by a failed virtual storage controller will generally fail themselves if the virtual storage controller is not responsive for more than a minute or less. Therefore, providing high availability of virtual storage controllers on a cloud platform generally results in significant additional storage cost or application disruption and/or failure.

### SUMMARY

A method for facilitating high availability storage services includes monitoring with a passive virtual storage controller executing on a host device an active virtual storage controller. A determination of when a failure of the active virtual storage controller has occurred is made with the passive virtual storage controller executing on the host device based on the monitoring. When the failure of the active virtual storage controller is determined to have occurred, one or more storage devices previously assigned to the active virtual storage controller are remapped to the passive virtual storage controller which is either maintaining a copy of the transaction log, or has access to an external copy (e.g., a transaction database server). The passive controller replays the transaction log, and transitions to the role of an active virtual storage controller, at which point it resumes serving data to the applications. Conversely, upon reboot the failed controller transitions to the role of a passive virtual storage controller.

A non-transitory computer readable medium having stored thereon instructions for facilitating high availability storage services comprising machine executable code which when executed by a processor, causes the processor to perform steps including monitoring an active virtual storage controller. A determination of when a failure of the active virtual storage controller has occurred is made based on the monitoring. When the failure of the active virtual storage controller is determined to have occurred, one or more storage devices perviously assigned to the active virtual storage controller are remapped to a passive virtual storage controller which is either maintaining a copy of the transaction log, or has access to an external copy (e.g., a transaction database server). The passive controller replays the transaction log, and transitions to the role of an active virtual storage controller, at which point it resumes serving data to the applications. Conversely, upon reboot the failed controller transitions to the role of a passive virtual storage controller.

A host device comprising a processor coupled to a memory and configured to execute programmed instructions stored in the memory to perform steps including monitoring an active virtual storage controller. A determination of when a failure of the active virtual storage controller has occurred is made based on the monitoring. When the failure of the active virtual storage controller is determined to have occurred, one or more storage devices previously assigned to the active virtual storage controller are remapped to a passive virtual storage controller which is either maintaining a copy of the transaction log, or has access to an external copy (e.g., a transaction database server). The passive controller replays the transaction log, and transitions to the role of an active virtual storage controller, at which point it resumes serving data to the applications. Conversely, upon reboot the failed controller transitions to the role of a passive virtual storage controller.

This technology provides a number of advantages including providing more efficient and effective methods, non-transitory computer readable medium, and devices for facilitating high availability storage services. With this technology, a passive virtual storage controller can assume the role of an active virtual storage controller in the event the active virtual storage controller fails without requiring the complex operation of giving back the traffic previously serviced by the active controller, reserving headroom in the active controller, or replicating any data. Additionally, with this technology, high availability can be provided for virtual storage controllers implemented in a cloud platform while minimizing the disruption to applications relying on the storage services provided by the virtual storage controllers.

### BRIEF DESCRIPTION OF THE DRAWINGS

FIG. 1 a block diagram of a network environment with an exemplary storage fabric including a plurality of exemplary host devices;

FIG. 2 is a block diagram of an exemplary host device on which at least a passive and an active virtual storage controller are executed;

FIG. 3 is a flowchart of an exemplary method for facilitating high availability storage services with an active virtual storage controller; and

FIG. 4 is a flowchart of an exemplary method for facilitating high availability storage services with a passive virtual storage controller.

### DETAILED DESCRIPTION

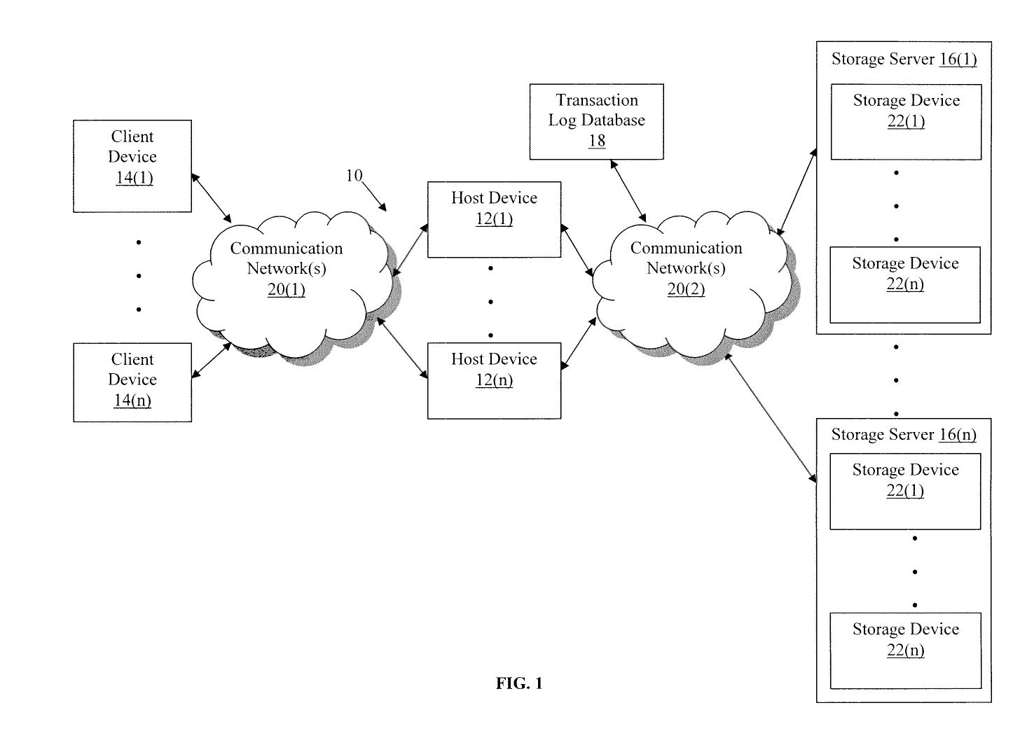

A network environment 10 including a storage fabric with exemplary host devices 12(1)-12(n) is illustrated in FIG. 1. The environment 10 in this example further includes client devices 14(1)-14(n), storage servers 16(1)-16(n), and an optional transaction log database 18, although this environment 10 can include other numbers and types of systems, devices, components, and/or elements in other configurations, such as multiple numbers of each of these apparatuses and devices. The client computing devices 14(1)-14(n) are in communication with the host devices 12(1)-12(n) through the communication network(s) 20(1) and the host devices 12(1)-12(n) are in communication with the storage servers 16(1)-16(n) and transaction log database through communication network(s) 20(2). This technology provides a number of advantages including methods, non-transitory computer readable medium, and devices that relatively efficiently facilitate high availability of storage services provided by virtual storage controllers in a cloud platform.

Each of the client devices 14(1)-14(n) in this example can include a processor, a memory, a network interface, an input device, and a display device, which are coupled together by a bus or other link, although each of the client devices can have other types and numbers of components or other elements and other numbers and types of network devices could be used. The client devices 14(1)-14(n) may run interface applications that provide an interface to make requests for and send content and/or data to the host devices 12(1)-12(n) via the communication network(s) 20(1), for example. Each of the client devices 14(1)-14(n) may be, for example, a conventional personal computer, a workstation, a smart phone, a virtual machine running in a cloud, or other processing and/or computing device.

Each of the storage servers 16(1)-16(n) in this example include a storage device 22(1)-22(n), a processor, and a network interface coupled together by a bus or other link. The storage devices 22(1)-22(n) in this example can include conventional magnetic disks, solid-state drives (SSDs), or any other type of stable, non-volatile storage device suitable for storing large quantities of data. The storage servers 16(1)-16(n) may be organized into one or more volumes of Redundant Array of Inexpensive Disks (RAID), although other types and numbers of storage servers in other arrangements can be used.

The optional transaction log database 18 can include any type of memory or storage device and can be located on one of the storage servers 16(1)-16(n) or a different server device in communication with one or more of the host devices 12(1)-12(n). The transaction log database 18 stores a copy of transaction logs maintained by active virtual storage controller(s) and can be provided in the network environment 10 particularly for implementations in which one passive virtual storage controller monitors a plurality of active virtual storage controllers (referred to herein as “n-way high availability”), as described and illustrated in more detail later, although the transaction log database 18 can also be utilized in other types of implementations.

The host devices 12(1)-12(n) in this example operate on behalf of the client devices 14(1)-14(n) to store and manage files or other units of data stored by the storage servers 16(1)-16(n). Accordingly, the host devices 12(1)-12(n) manage the storage servers 16(1)-16(n) in this example and receive and respond to various read and write requests from the client devices 14(1)-14(n) directed to data stored in, or to be stored in, one or more of the storage servers 16(1)-16(n).

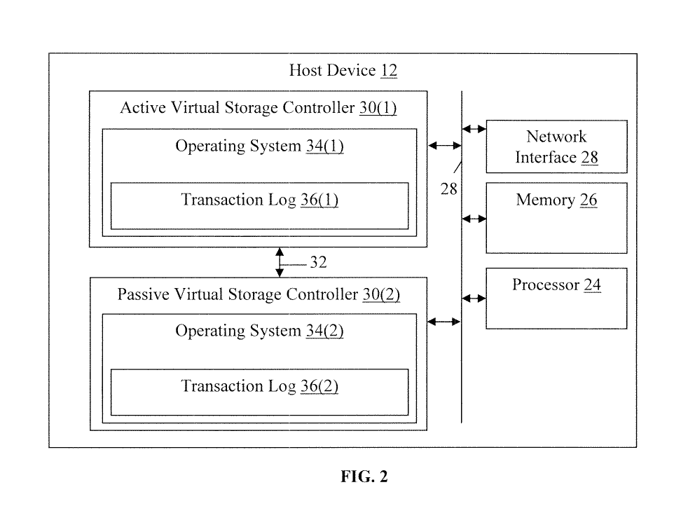

Referring more specifically to FIG. 2, a block diagram of one of the exemplary host devices 12(1)-12(n) is illustrated. In this example, the host device 12 includes a processor 24, a memory 26, and at least one network interface 28, coupled together by a bus 28 or other communication link. The host device 12 further includes an active virtual storage controller 30(1) and a passive virtual storage controller 30(2) coupled together by an interconnect 32 or other communication link, although the active and passive virtual storage controllers 30(1) and 30(2) can be coupled together in other manners and additional virtual storage controllers may be executing on the host device 12 at any time.

The processor 24 of the host device 12 may execute programmed instructions stored in a memory 26 for various functions and/or operations illustrated and described herein. The memory 26 of the host device 12 may include any of various forms of read only memory (ROM), random access memory (RAM), Flash memory, non-volatile, or volatile memory, or the like, or a combination of such devices for example. The memory 26 can store instructions comprising a host operating system that, when executed by the processor 24, generates a hypervisor that interfaces hardware of the host device 12 with the active and passive virtual storage controllers 30(1) and 30(2), such as through virtual machine(s), for example, although the active and passive virtual storage controllers 30(1) and 30(2) can be executed and implemented in other manners.

The active virtual storage controller 30(1) currently services traffic associated with the storage and retrieval of data stored by one or more of the storage servers 16(1)-16(n). The passive virtual storage controller 30(2) monitors the active virtual storage controller 30(2) to determine when the active virtual storage controller 30(1) fails, at which time the passive virtual storage controller 30(2) assumes the role of the active virtual storage controller 30(1), as described and illustrated in more detail later. Each of the active and passive virtual storage controllers 30(1) and 30(2) in this example has an associated operating system 34(1) and 34(2) and transaction log 36(1) and 36(2), respectively. The transaction logs 36(1) and 36(2) are used by the active and passive virtual storage controllers 30(1) and 30(2), respectively, to store information associated with transactions received from the client devices 14(1)-14(n), for example, although the transaction logs 36(1) and 36(2) can also be used to store other information received from other sources. In other examples, the passive virtual storage controller 30(2) does not maintain a transaction log and instead retrieves a transaction log associated with a failed active virtual storage controller 30(1) from the optional transaction log database 18, as described and illustrated in more detail later.

The active and passive designations for the virtual storage controllers 30(1) and 30(2) are for exemplary purposes and indicate the current role of the virtual storage controllers 30(1) and 30(2), although either of the virtual storage controllers 30(1) and 30(2) could be operating in an active or passive role at any time, as described and illustrated in more detail later. Additionally, the host device 12 includes both an active virtual storage controller 30(1) and a passive virtual storage controller 30(2) for exemplary purposes only and, in other examples, either of the active virtual storage controller 30(1) or the passive virtual storage controller 30(2) could be executing on a different one of the host devices 12(1)-12(n), as described and illustrated in more detail later. Moreover, any one or more of the host devices 12(1)-12(n) could include any number of active virtual storage controllers associated with any number of passive virtual storage controllers. For example, a plurality of active virtual storage controllers could be associated with one virtual storage controller in an n-way high availability implementation, also as described and illustrated in more detail later.

The network interface 28 of the host device 12 in this example can include a plurality of network interface controllers (NICs), for example, each associated with a respective one of the active and passive virtual storage controllers 30(1) and 30(2), for operatively coupling and communicating between the host device 12, the client devices 14(1)-14(n), and the storage servers 16(1)-16(n), which are coupled together by the communication network(s) 20(1) and 20(2), although other types and numbers of communication networks or systems with other types and numbers of connections and configurations to other devices and elements also can be used.

By way of example only, the communication network(s) 20(1) and/or 20(2) can use TCP/IP over Ethernet and industry-standard protocols, including NFS, CIFS, SOAP, XML, LDAP, and SNMP, although other types and numbers of communication networks, can be used. The communication network(s) 20(1) and 20(2) in this example may employ any suitable interface mechanisms and network communication technologies including, for example, teletraffic in any suitable form (e.g., voice, modem, and the like), Public Switched Telephone Network (PSTNs), Ethernet-based Packet Data Networks (PDNs), combinations thereof, and the like. The communication network(s) 20(1) and 20(2) may also comprise any local area network and/or wide area network (e.g., Internet), although any other type of traffic network topologies may be used.

Although examples of the host device 12, client devices 14(1)-14(n), storage servers 16(1)-16(n), and transaction log database 18 are described herein, it is to be understood that the devices and systems of the examples described herein are for exemplary purposes, as many variations of the specific hardware and software used to implement the examples are possible, as will be appreciated by those skilled in the relevant art(s). In addition, two or more computing systems or devices can be substituted for any one of the systems in any embodiment of the examples.

The examples also may be embodied as a non-transitory computer readable medium having instructions stored thereon for one or more aspects of the present technology as described and illustrated by way of the examples herein, as described herein, which when executed by the processor, cause the processor to carry out the steps necessary to implement the methods of this technology as described and illustrated with the examples herein.

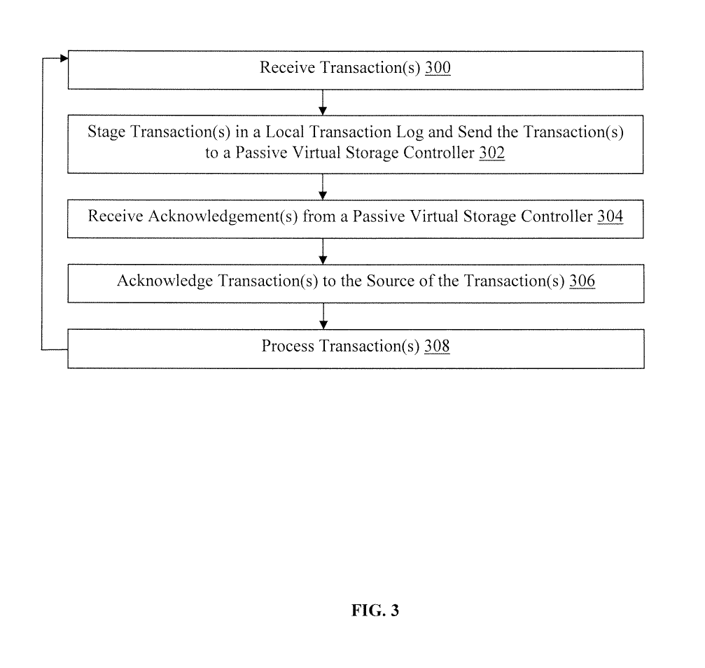

An exemplary method for facilitating high availability storage services will now be described with reference to FIGS. 1-4. Referring more specifically to FIG. 3, an exemplary method for facilitating high availability storage services with the active virtual storage controller 30(1) is illustrated. In step 300 in this example, the active virtual storage controller 30(1) executing on the host device 12 receives one or more transactions, such as from one or more of the client devices 14(1)-14(n), for example, although the one or more transactions can be received from other sources. Exemplary transactions can include requests from one of the client devices 14(1)-14(n) to read or write data, although other numbers and types of transactions can be received in step 300.

In step 302, the active virtual storage controller 30(1) stages the one or more transactions, such as by storing the one or more transactions in the transaction log 36(2), for example. The one or more transactions are staged because they may be received more quickly than they can be processed by the active virtual storage controller 30(1). Generally, processing the transactions using the storage servers 16(1)-16(n) requires a relatively long period of time considering the mechanical nature of the operation of storing and retrieving data on disks of the storage servers 16(1)-16(n).

In this example, the active virtual storage controller 30(2) also sends the one or more transactions to the passive virtual storage controller 30(2), which stores the one or more transactions, as described and illustrated in more detail later. In another example, such as an n-way high availability implementation in which a plurality of active virtual storage controllers are monitored by one passive virtual storage controller, the active virtual storage controller can send the one or more transactions to the transaction log database 18 with a unique identifier of the active virtual storage controller 30(1). Upon receipt, the transaction log database 18 stores the one or more transactions as associated with the active virtual storage controller 30(1). Optionally, only a subset of the one or more transactions received in step 300 are sent to the passive virtual storage controller 30(2), such as those write transactions that affect data stored by the storage servers 16(1)-16(n), for example.

In step 304 in this example in which the one or more transactions are sent by the active virtual storage controller 30(1) to the passive virtual storage controller 30(2), the active virtual storage controller 30(1) receives one or more acknowledgements from the passive virtual storage controller 30(2) of receipt of each of the one or more transactions. After receiving the one or more acknowledgements in step 304, the active virtual storage controller 30(1) acknowledges the one or more transactions in step 306 to the source of the one or more transactions, such as one or more of the client devices 14(1)-14(n), for example.

In step 308, the active virtual storage controller 30(1) executing on the host device 12 processes the one or more transactions received in step 300, such as by retrieving requested data from one or more of the storage servers 16(1)-16(n) and/or writing data to one or more of the storage servers 16(1)-16(n), for example.

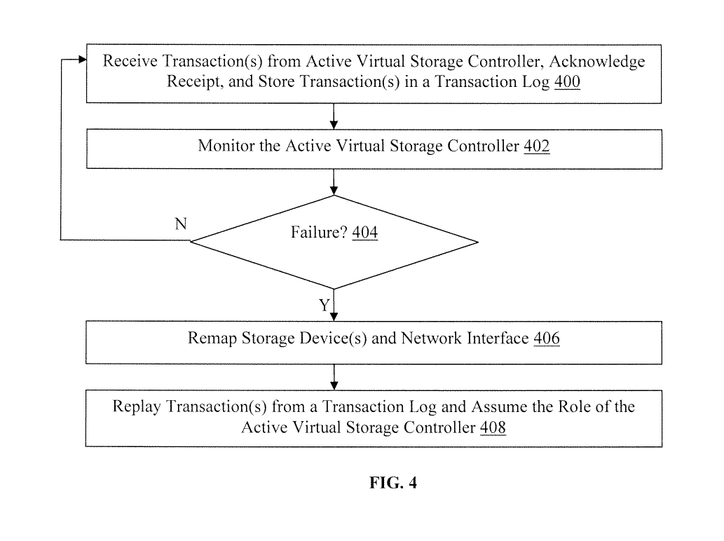

Referring more specifically to FIG. 4, an exemplary method for facilitating high availability storage services with a passive virtual storage controller is illustrated. In step 400 in this example, the passive virtual storage controller 30(2) executing on the host device 12, receives one or more transactions from the active virtual storage controller 30(1), such as sent by the active virtual storage controller 30(1) as described and illustrated earlier with reference to step 302 of FIG. 3, for example.

Referring back to step 400 in FIG. 4, the passive virtual storage controller 30(2) also acknowledges receipt of the one or more transactions and stores the one or more transactions in the transaction log 36(2). Accordingly, the passive virtual storage controller 30(2) in this example effectively maintains a copy of the transaction log 36(1) that is used by the active virtual storage controller 30(1) to stage and process transactions, as described and illustrated earlier.

In step 402, the passive virtual storage controller 30(2) monitors the active virtual storage controller 30(2). The monitoring can be based on a heartbeat signal periodically sent from the active virtual storage controller 30(1) to the passive virtual storage controller 30(2) using the interconnect 32 or other means. The active virtual storage controller 30(1) can be configured to periodically initiate the heartbeat signal or the passive virtual storage controller 30(2) can periodically send a message using the interconnect 32 to prompt the active virtual storage controller 30(1) to send the heartbeat signal.

In n-way high availability implementation, for example, the heartbeat message received from the active virtual storage controller 30(1) includes a unique identifier of the active virtual storage controller 30(2), which is used as described and illustrated in more detail later. Other methods of monitoring the health of the active virtual storage controller 30(1) can also be used.

In step 404, the passive virtual storage controller 30(2) determines whether the active virtual storage controller 30(1) has entered a failure state. In this example, the passive virtual storage controller 30(2) can determine whether the active virtual storage controller 30(1) has failed based on whether it has received a heartbeat signal within a specified period of time since a prior heartbeat signal. In another example, the active virtual storage controller 30(1) is configured to communicate to the passive virtual storage controller 30(2) using the interconnect 32 that it has entered a failure state. Other methods of determining that the active virtual storage controller 30(1) has failed can also be used.

In this example, the passive virtual storage controller 30(2) is executed by the same host device 12 and using the same hypervisor as the active virtual storage controller 30(1). Accordingly, the failure identified by the passive virtual storage controller 30(2) is of the operating system 34(1). However, in examples in which the passive virtual storage controller 30(2) and the active virtual storage controller 30(1) are executed by different ones of the host devices 12(1)-12(n), the failure could be a hypervisor or hardware failure, for example.

If the passive virtual storage controller 30(2) determines that the active virtual storage controller 30(1) has not failed, then the No branch is taken back to step 400 and the passive virtual storage controller 30(2) continues to receive one or more transactions from the active virtual storage controller 30(1), as described and illustrated earlier. Any of steps 400-404 can be performed by the passive virtual storage controller 30(2) in parallel.

Referring back to step 404, if the passive virtual storage controller 30(2) determines that the active virtual storage controller 30(1) has failed, then the Yes branch is taken to step 406. In step 406, the passive virtual storage controller 30(2) remaps at least one or more of the storage devices 22(1)-22(n) previously assigned to the active virtual storage controller 30(1) to be assigned to the passive virtual storage controller 30(2). The remapped one or more of the storage devices 22(1)-22(n) can also be virtual storage devices corresponding to one or more of the storage devices 22(1)-22(n) or portions thereof, for example. In one example, in order to remap the one or more of the storage devices 22(1)-22(n), the passive virtual storage controller 32(2) can make call(s) to an application programming interface (API) supported by the cloud platform provider, for example, although other methods of remapping the one or more of the storage devices 22(1)-22(n) can also be used.

In some examples, the passive virtual storage controller 30(2) also remaps the network interface 28, or more specifically a network interface controller (NIC) of the network interface 28, previously assigned to the active virtual storage controller 30(1) to be associated with the passive virtual storage controller 30(1). By remapping the NIC, an application associated with one or more of the client devices 14(1)-14(n) previously communicating with the operating system 34(1) of the active virtual storage controller 30(1) can communicate with the operating system 34(2) of the passive virtual storage controller 30(2). The NIC can be remapped using call(s) to the API supposed by the cloud platform provider or through IP address translation of the traffic received from one or more of the client devices 14(1)-14(n), as managed by one or more of the operating systems 34(1) and/or 34(2), for example, although other methods of remapping the NIC can also be used.

In step 408, the passive virtual storage controller 30(2) replays the transactions stored in the transaction log 36(2) and effectively assumes the role of the active virtual storage controller 30(1). Upon rebooting in response to the failure, the active virtual storage controller 30(1) will effectively assume the role of the passive virtual storage controller 30(2). In this example, the transaction log 36(2) is a local transaction log managed by the passive virtual storage controller 30(2).

In other examples, such as in an n-way high availability implementation, the copy of the transaction log 36(1) can be maintained by the active virtual storage controller 30(1) in the transaction log database 18. Accordingly, in these examples, the passive virtual storage controller 30(2) can use a unique identifier of the active virtual storage controller 30(1), such as communicated with the heartbeat signal, for example, to retrieve the transaction log corresponding to the active virtual storage controller 30(1) that failed.

With this technology, a passive virtual storage controller maintains or accesses a copy of the transaction log utilized by a failed active virtual storage controller so that it can assume the role of the failed virtual storage controller by remapping the storage devices previously assigned to the failed virtual storage controller. Accordingly, high availability of virtual storage controllers can be provided on a cloud platform without requiring replication of data and associated cost and with reduced disruption to applications utilizing the virtual storage controllers.

Having thus described the basic concept of the invention, it will be rather apparent to those skilled in the art that the foregoing detailed disclosure is intended to be presented by way of example only, and is not limiting. Various alterations, improvements, and modifications will occur and are intended to those skilled in the art, though not expressly stated herein. These alterations, improvements, and modifications are intended to be suggested hereby, and are within the spirit and scope of the invention. Additionally, the recited order of processing elements or sequences, or the use of numbers, letters, or other designations therefore, is not intended to limit the claimed processes to any order except as may be specified in the claims. Accordingly, the invention is limited only by the following claims and equivalents thereto.

What is claimed is:

1. A method for facilitating high availability storage services, the method comprising:
monitoring, with a passive virtual storage controller executing on a host device, an active virtual storage controller;
determining, with the passive virtual storage controller executing on the host device, when a failure of the active virtual storage controller has occurred based on the monitoring; and
remapping one or more storage devices previously assigned to the active virtual storage controller to the passive virtual storage controller, and replaying one or more transactions in a transaction log, with the passive virtual storage controller executing on the host device, when the failure of the active virtual storage controller is determined to have occurred.

2. The method of claim 1, further comprising:
receiving, with the passive virtual storage controller executing on the host device, the one or more transactions from the active virtual storage controller;
storing, with the passive virtual storage controller executing on the host device, the one or more transactions in the transaction log; and
acknowledging, with the passive virtual storage controller executing on the host device, receipt of each of the one or more transactions to the active virtual storage controller in response to receiving each of the one or more transactions.

3. The method of claim 1, wherein the monitoring further comprises receiving a heartbeat periodically from the active virtual controller and a failure of the active virtual controller is determined to have occurred when a heartbeat is not received from the active virtual controller for a specified period of time.

4. The method of claim 3, wherein the transaction log is maintained by the active virtual storage controller in a transaction log database, the heartbeat comprises an identifier of the active virtual controller, and the method further comprises retrieving the transaction log from the transaction log database based on the identifier.

5. The method of claim 1, wherein the remapping further comprises remapping a network interface previously assigned to the active virtual storage controller to be assigned to the passive virtual storage controller.

6. A host device, comprising:
a processor coupled to a memory and configured to execute programmed instructions stored in the memory to perform steps comprising:
monitoring an active virtual storage controller;
determining when a failure of the active virtual storage controller has occurred based on the monitoring; and
remapping one or more storage devices previously assigned to the active virtual storage controller to a passive virtual storage controller and replaying one or more transactions in a transaction log, when the failure of the active virtual storage controller is determined to have occurred.

7. The device of claim 6, wherein the processor is further configured to execute programmed instructions stored in the memory to perform steps further comprising:
receiving the one or more transactions from the active virtual storage controller;
storing the one or more transactions in the transaction log; and
acknowledging receipt of each of the one or more transactions to the active virtual storage controller in response to receiving each of the one or more transactions.

8. The device of claim 6, wherein the monitoring further comprises receiving a heartbeat periodically from the active virtual controller and a failure of the active virtual controller is determined to have occurred when a heartbeat is not received from the active virtual controller for a specified period of time.

9. The device of claim 8, wherein the transaction log is maintained by the active virtual storage controller in a transaction log database, the heartbeat comprises an identifier of the active virtual controller, and the processor is further configured to execute programmed instructions stored in the memory to perform steps further comprising retrieving the transaction log from the transaction log database based on the identifier.

10. The device of claim 6, wherein the remapping further comprises remapping a network interface previously assigned to the active virtual storage controller to be assigned to the passive virtual storage controller.

11. A non-transitory computer readable medium having stored thereon instructions for facilitating high availability storage services comprising machine executable code which when executed by a processor, causes the processor to perform steps comprising:
monitoring an active virtual storage controller;
determining when a failure of the active virtual storage controller has occurred based on the monitoring; and
remapping one or more storage devices previously assigned to the active virtual storage controller to a passive virtual storage controller and replaying one or more transactions in the transaction log, when the failure of the active virtual storage controller is determined to have occurred.

12. The medium of claim 11, wherein the machine executable code when executed by the processor further causes the processor to perform steps further comprising:
receiving the one or more transactions from the active virtual storage controller;
storing the one or more transactions in the transaction log; and
acknowledging receipt of each of the one or more transactions to the active virtual storage controller in response to receiving each of the one or more transactions.

13. The medium of claim 11, wherein the monitoring further comprises receiving a heartbeat periodically from the active virtual controller and a failure of the active virtual controller is determined to have occurred when a heartbeat is not received from the active virtual controller for a specified period of time.

14. The medium of claim 13, wherein the transaction log is maintained by the active virtual storage controller in a transaction log database, the heartbeat comprises an identifier of the active virtual controller, and the machine executable code when executed by the processor further causes the processor to perform steps further comprising retrieving the transaction log from the transaction log database based on the identifier.

15. The medium of claim 11, wherein the remapping further comprises remapping a network interface previously assigned to the active virtual storage controller to be assigned to the passive virtual storage controller.
